(19) United States
(12) Patent Application Publication
(10) Pub. No.: US 2014/0044637 A1
(43) Pub. Date: Feb. 13, 2014

(54) Method of pre treatment of lizardite

(71) Applicants: Bogdan Z. Dlugogorski, Anna Bay (AU); Reydick Balucan, Wallsend (AU); Eric M. Kennedy, Newcastle (AU)

(72) Inventors: Bogdan Z. Dlugogorski, Anna Bay (AU); Reydick Balucan, Wallsend (AU); Eric M. Kennedy, Newcastle (AU)

(21) Appl. No.: 13/989,584

(22) PCT Filed: Nov. 25, 2011
(86) PCT No.: PCT/AU2011/001536

§ 371 Date: Oct. 31, 2013

(30) Foreign Application Priority Data
Nov. 26, 2010 (AU) 2010905240

(51) Int. Cl. B01J 20/30

(52) U.S. Cl. CPC B01J 20/3078
USPC 423/331

(57) ABSTRACT

A method of pre treating lizardite for use in the mineral sequestration of carbon dioxide, the method including heating the lizardite at a temperature of less than 600° C. until the lizardite contains between about 10% to about 40% residual hydroxyls.

The present invention relates to a method of pre treatment for alkaline earth metal silicates prior to their use in carbon sequestration and in particular to a method of pre treatment for the lizardite polymorph of serpentine.

### BACKGROUND

One proposed method to sequester carbon is to react naturally occurring Mg and Ca containing minerals with carbon dioxide to form carbonates. Such a method has some significant advantages including that the process is thermodynamically favourable and occurs naturally. In addition, the minerals such as alkaline earth metal silicates including olivine, serpentine and wollastonite are abundant. Moreover, the carbonates that are produced from such a method are stable and thus re-release of carbon dioxide into the atmosphere is not an issue. However, conventional carbonation pathways are slow under ambient temperatures and pressures. The significant challenge is to identify an industrially and environmentally viable carbonation route that will allow such a method of sequestering carbon to be economically viable.

Reaction rates for carbonation may be accelerated by decreasing the particle size of the minerals through pulverisation, raising reaction temperature and pressure, changing solution chemistry and using catalysts/additives.

An alternative approach increases mineral reactivity by the removal of part of the hydroxyl groups of a serpentinite mineral. This activation destroys mineral crystallinity, making the magnesium accessible for carbonation in an aqueous phase.

One such approach involved activating a mineral of serpentine via electrical heating at 630° C. for 120 min using coal-derived power. However in the modern day this is energetically prohibitive and impractical necessitating alternate thermal activation strategies. Industrial-scale thermal processing of serpentinites, with integrated heat recovery system is especially attractive. Heat efficient vessels such as direct-fired, refractory-lined rotary calciners utilising the heats from combustion of carbonaceous-hydrocarbonaceous fuels and gasification processes could reduce the overall energy requirements.

The present invention seeks to provide a pre treatment method for activating serpentine minerals which is less energy intensive.

### SUMMARY

According to one aspect the present invention provides a method of pre treating lizardite for use in the mineral sequestration of carbon dioxide, the method including heating the lizardite at a temperature of less than 600° C. until the lizardite contains between about 10% to about 40% residual hydroxyls.

In one form the lizardite is heated at a temperature of above 400° C. and in a preferred form above 500° C.

In one form the period of time is between about 1 minute and about 160 minutes.

In one form the lizardite is heated at a temperature of between about 550° C. and about 595° C. for a period of time that is between about 5 minutes and 150 minutes.

In one form when the lizardite is heated at a temperature of about 550° C. the period of time is between about 60 minutes and about 165 minutes. In one form when the lizardite is heated at a temperature of about 570° C. the period of time is between about 40 minutes and about 95 minutes. In one form when the lizardite is heated at a temperature of about 590° C. the period of time is between about 10 minutes and about 40 minutes.

According to another aspect the present invention provides a method of pre treating lizardite for use in the mineral sequestration of carbon dioxide, the method including heating the lizardite at a temperature and time relationship represented by the area between the 40% OH line and the 10% OH line located on the graph included herein as FIG. 1.

In one form the method further includes an initial heat-up period. In one form the initial heat-up period is at about 30° C. min-1 from ambient temperature.

In one form the lizardite is crushed prior to the method of pre-treatment.

In one form the lizardite is ground prior to the method of pre treatment.

In one form the lizardite has an average particle size of between 1 μm to 250 μm. In one form the lizardite has an average particle size of between about 30 μm to about 80 μm. In another form the lizardite has an average particle size of about 38 μm.

### BRIEF DESCRIPTION OF THE ACCOMPANYING FIGURES

The present invention will become better understood from the following detailed description of various non-limiting embodiments thereof, described in connection with the accompanying figures, wherein:

FIG. 1 is a graph outlining the temperature and time relationship for the activation of lizardite indicated by the percent of residual hydroxyl groups; and,

FIG. 2 is graph outlining the temperature and time relationship for the activation of antigorite indicated by the percent of residual hydroxyl groups.

### DETAILED DESCRIPTION OF EMBODIMENTS OF THE INVENTION AND THE ACCOMPANYING FIGURES

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

The serpentine group of alkaline earth metal silicates describes a group of common rock-forming minerals. There are three important mineral polymorphs of serpentine: antigorite, chrysotile and lizardite.

As used herein the term ‘lizardite’ also refers to that polymorph of serpentine known as orthoantigorite.

In was surprisingly found that in order to activate the mineral polymorph lizardite a substantially lower temperature is required than the temperature required to activate the mineral polymorph antigorite. In past attempts high temperatures above 630° C. were used to activate antigorite which then obtained high conversions in the subsequent carbonation step. However, the conversion of lizardite was low (˜40%), when lizardite was activated to the same temperature.

From this, it was previously assumed that to get better conversion of lizardite, this mineral needs to be heated to even higher temperature or for longer periods of times. However, it was surprisingly found that the opposite is true. In order to activate the mineral lizardite and remove between 60 and 90% of the hydroxyl groups the mineral needs to be heated at lower temperatures and/or for a shorter period of time.

Heat activation of antigorite is best performed at the mineral TB_{p,B} where the rate is at its maximum. FIG. 2 depicts the temperature and time relationship for the activation of antagorite to achieve various degrees of dehydroxylation. It was found that the rate was at a maximum where the overall process, which consists of heat-up and isothermal stages, is completed within 34 min. The heat-up period, from 30 to 730° C. at 30° C. min-¹ requires 24 min, while the isothermal stage at 730° C. to attain 90% dehydroxylation adds 6 min to the operation. During the heat-up period, approximately 60% of total hydroxyls are removed once the mineral temperature reaches 500° C. Full dehydroxylation requires 10 min of the isothermal operation at 730° C. But such operation is undesirable, as the mineral's reactivity deteriorates in excess of 90% dehydroxylation.

The duration and temperature of dehydroxylation define the reactivity of the activated mineral during dissolution step in the aqueous carbonation. It has been observed that ≦90% dehydroxylation leads to optimal reactivity. Generally, 120 min had been previously used to activate particles of both antigorite and lizardite, −38 μm in size. However, carbonation conversions were significantly higher for antigorite at 92% than lizardite at 40%.

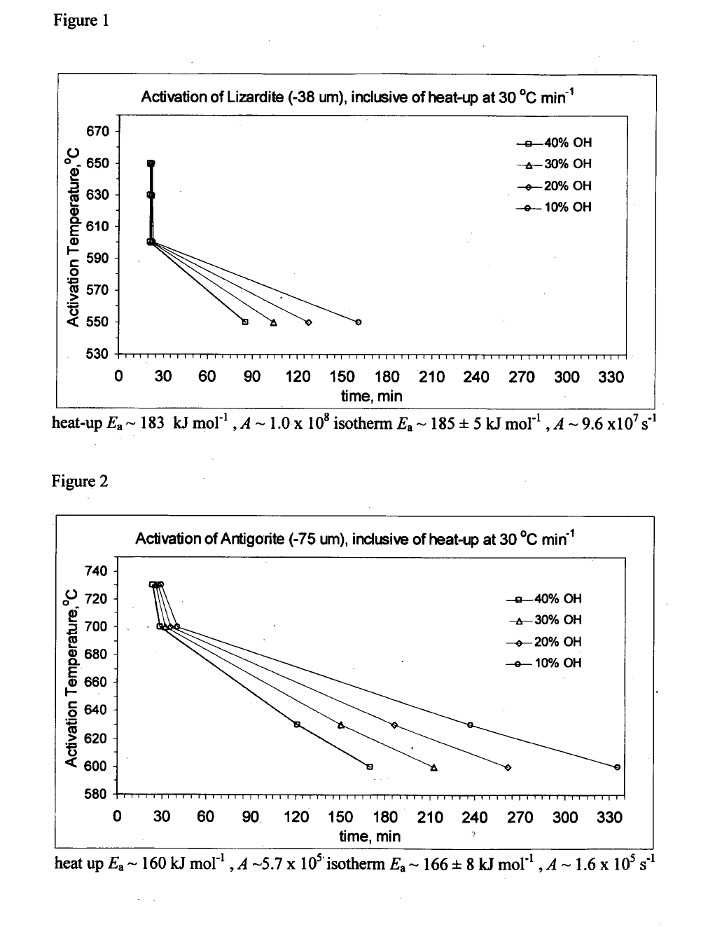

FIG. 1 depicts the temperature and time relationship for the activation of lizardite and shows that isothermal activation at 630° C. for 120 min fully dehydroxylates lizardite but as can be seen from FIG. 2 only removes ˜60% of antigorite's OH content. The higher conversion for antigorite compared to lizardite may be attributed to the structural composition.

It has been found that serpentine activation must not exceed 90% dehydroxylation to maintain an open, layered structure. Based on these observed structural changes, a properly activated antigorite appears to contain between 10 and 40% residual OH. Thus, the optimal strategy for thermally activating antigorite amounts to the production of a 60-90% dehydroxylated mineral isothermally at 730° C. for ≦6 min. On the other hand, the present results indicate that the reason of low activity of lizardite rests with excessive duration of activation that led to the collapse in the mineral structure and formation of relatively unreactive enstatite upon full dehydroxylation.

FIG. 1 depicts the temperature and time relationship for the activation of lizardite to achieve various degrees of dehydroxylation. It was found that heating to a maximum of 590° C. the overall process, which consists of heat-up and isothermal stages, is completed within 55 min. The heat-up period, from 30 to 590° C. at 30° C. min-¹ requires about 19 min, while the isothermal stage at 590° C. to attain 90% dehydroxylation adds 36 min to the operation. Heating to a maximum temperature of 570° C. the process took 18 minutes to heat up to the maximum temperature a further 47 minutes to attain lizardite with 60% dehydroxylation and a further 32 minutes to reach 90% dehydroxylation.

Many modifications will be apparent to those skilled in the art without departing from the scope of the present invention.

1-13. (canceled)

14. A method of pre treating lizardite for use in the mineral sequestration of carbon dioxide, the method including heating the lizardite at a temperature of less than 600° C. until the lizardite contains between about 10% to about 40% residual hydroxyls.

15. A method according to claim 14 wherein the lizardite is heated at a temperature above 500° C.

16. A method according to claim 14 wherein the period of time is between about 1 minute and about 160 minutes.

17. A method according to claim 14 wherein the lizardite is heated at a temperature between about 550° C. and about 595° C. for a period of time that is between about 5 minutes and 150 minutes.

18. A method according to claim 17 wherein when the lizardite is heated at a temperature of about 550° C. the period of time is between about 60 minutes and about 165 minutes.

19. A method according to claim 17 wherein when the lizardite is heated at a temperature of about 570° C. the period of time is between about 40 minutes and about 95 minutes.

20. A method according to claim 17 wherein when the lizardite is heated at a temperature of about 590° C. the period of time is between about 10 minutes and about 40 minutes.

21. A method according to claim 14 wherein the method further includes an initial heat-up period at about 30° C. min⁻¹.

22. A method according to claim 14 wherein the lizardite is crushed prior to the method of pre-treatment.

23. A method according to claim 14 wherein the lizardite is ground prior to the method of pre treatment.

24. A method according to claim 14 wherein the lizardite has an average particle size of between 1 μm to 250 μm.

25. A method according to claim 24 wherein the lizardite has an average particle size of between about 30 μm to about 80 μm.
